(19) United States
(12) Patent Application Publication
(10) Pub. No.: US 2011/0273883 A1
(43) Pub. Date: Nov. 10, 2011

(54) WATERPROOF HOUSING AND ILLUMINATION APPARATUS USING THE SAME

(75) Inventor: PING-JUNG TSAI, Chu-Nan (TW)

(73) Assignee: FOXSEMICON INTEGRATED TECHNOLOGY, INC., Chu-Nan (TW)

(21) Appl. No.: 12/859,186

(22) Filed: Aug. 18, 2010

(30) Foreign Application Priority Data
May 5, 2010 (TW) 99114388

(51) Int. Cl. F21S 4/00; F21V 21/00; F21V 15/01

(52) U.S. Cl. 362/249.02; 362/362; 362/368

(57) ABSTRACT

A lamp housing used in an outdoor illumination apparatus includes an outer shell and an inner waterproof liner. The inner waterproof liner is located inside the outer shell. A power supply module is inside the inner waterproof liner. The lamp housing utilizes a double waterproof structure to maximize waterproof effectiveness. Furthermore, an illumination apparatus utilizing the lamp housing is also provided.

### TECHNICAL FIELD

The disclosure relates to illumination technology, and particularly to an illumination apparatus using a lamp housing which is waterproof.

### DESCRIPTION OF THE RELATED ART

Light emitting diodes' (LEDs) many advantages, such as high luminosity, low operational voltage, low power consumption, compatibility with integrated circuits, easy driving, long term reliability, and environmental friendliness have promoted their wide use as a light source, such that they are commonly applied in environmental lighting.

A commonly used outdoor illumination apparatus utilizes a single housing to provide waterproofing. However, during heavy rainfall or other extreme conditions, moisture is able to permeate the housing. A power supply of the illumination apparatus can short-circuit and the illumination apparatus malfunction.

What is needed, therefore, is a lamp housing which can ameliorate the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present lamp. Moreover, in the drawings, like reference numerals designate corresponding parts throughout the views.

FIG. 1 is a perspective view of a lamp housing in accordance with a first embodiment, in which a cover of the lamp housing is removed for clarity.

FIG. 2 is a top view of an illumination apparatus consisting of the lamp housing of FIG. 1 and a plurality of solid state lighting modules assembled to the lamp housing.

FIG. 3 is a right side view of the illumination apparatus of FIG. 2.

FIG. 4 is a perspective view of the illumination apparatus of FIG. 2, wherein the lamp housing has the cover mounted thereon which is securely connected to a seat of the lamp housing.

FIG. 5 is a perspective view of a streetlamp having the illumination apparatus of FIG. 4.

### DETAILED DESCRIPTION

Embodiments of a lamp housing as disclosed are described in detail here with reference to the drawings.

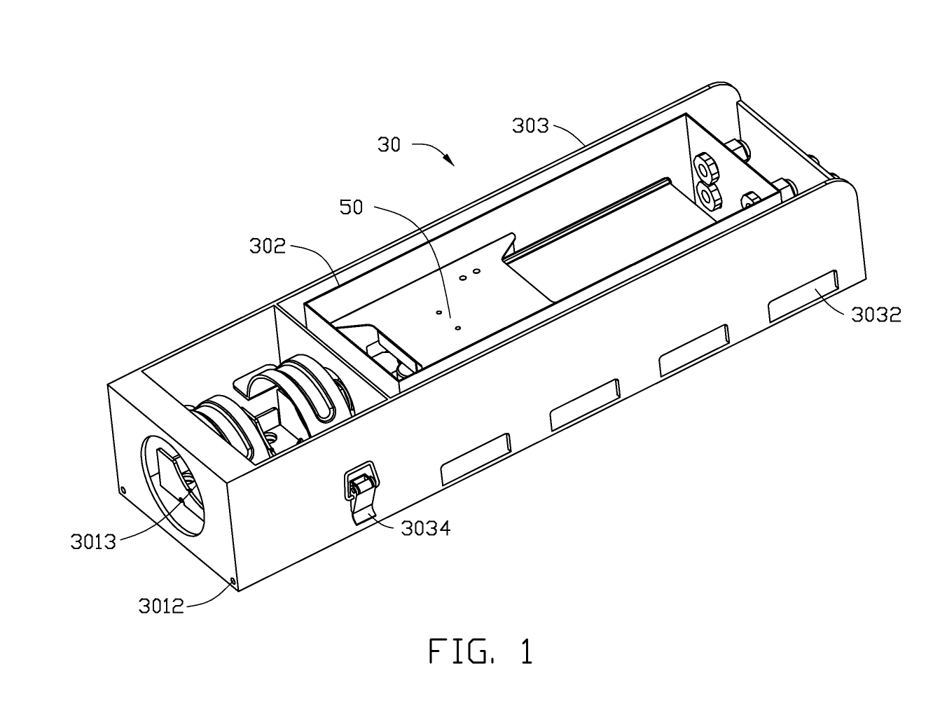

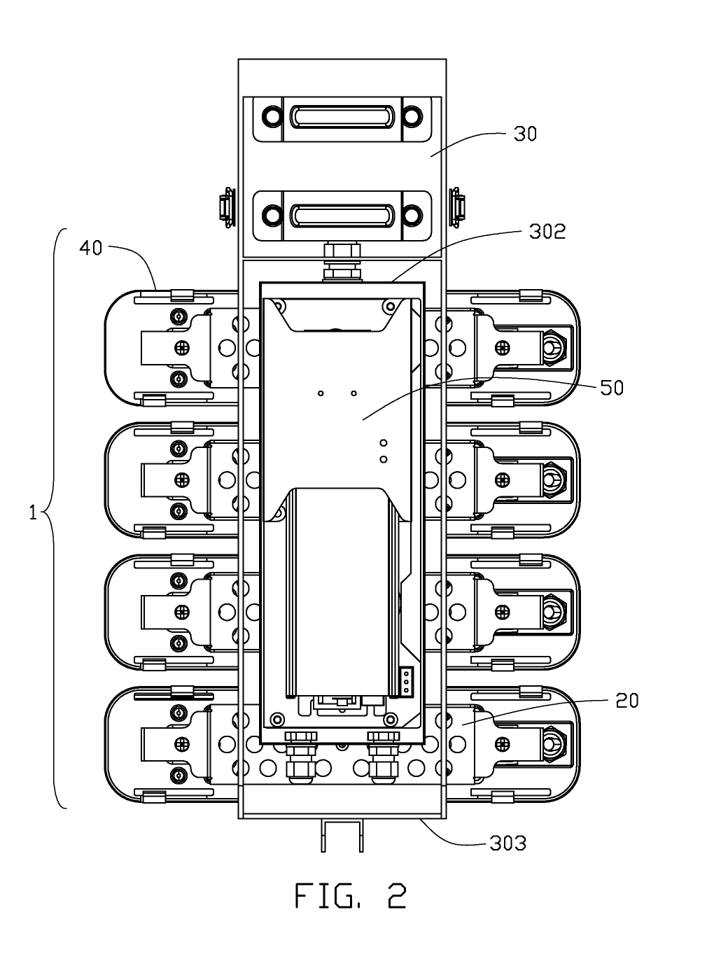

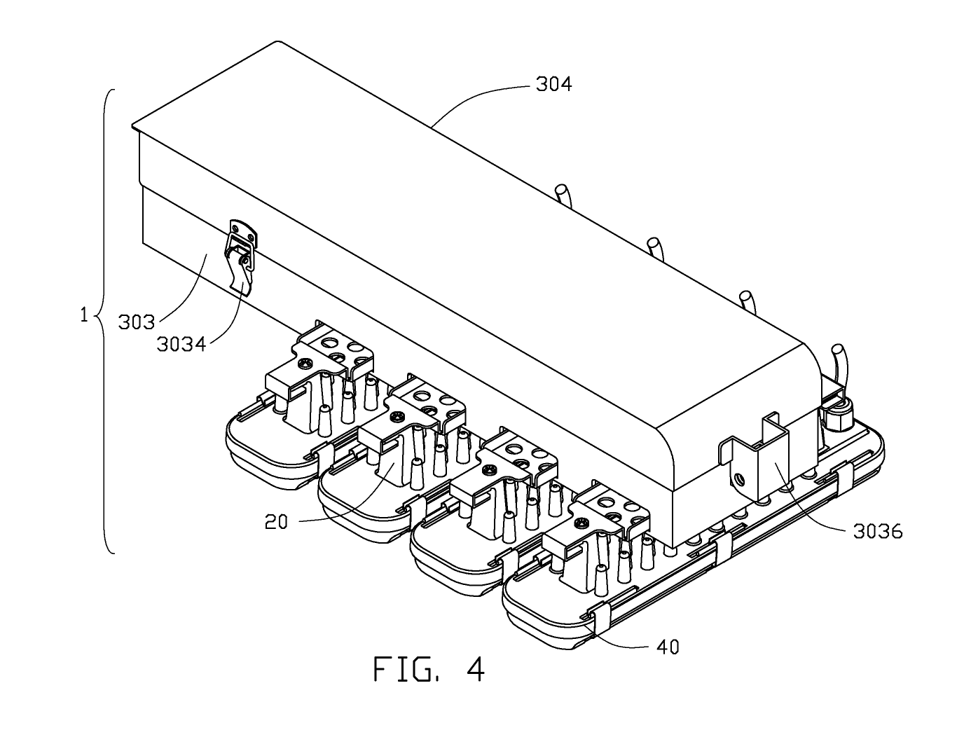

Referring to FIG. 1, a lamp housing 30 includes a seat 303 enclosing an inner waterproof liner 302 housing a power supply module 50. The seat 303 is securely connected with a cover 304, fixed by a fastener (as shown in FIG. 4) to totally enclose the power supply module 50. The seat 303 defines a plurality of channels 3032 in a lower portion thereof, which are capable of accommodating a plurality of solid state lighting modules 40 to thereby form an illumination apparatus 1 (FIG. 2) for providing illumination output. The solid state lighting modules 40 are mounted below the lamp housing 30. The inner waterproof liner 302 is waterproof material, such as rubber or silicon. The seat 303 and the cover 304 cooperatively form an outer shell for the lamp housing 30. The seat 303 and the cover 304 are made of metal or plastic.

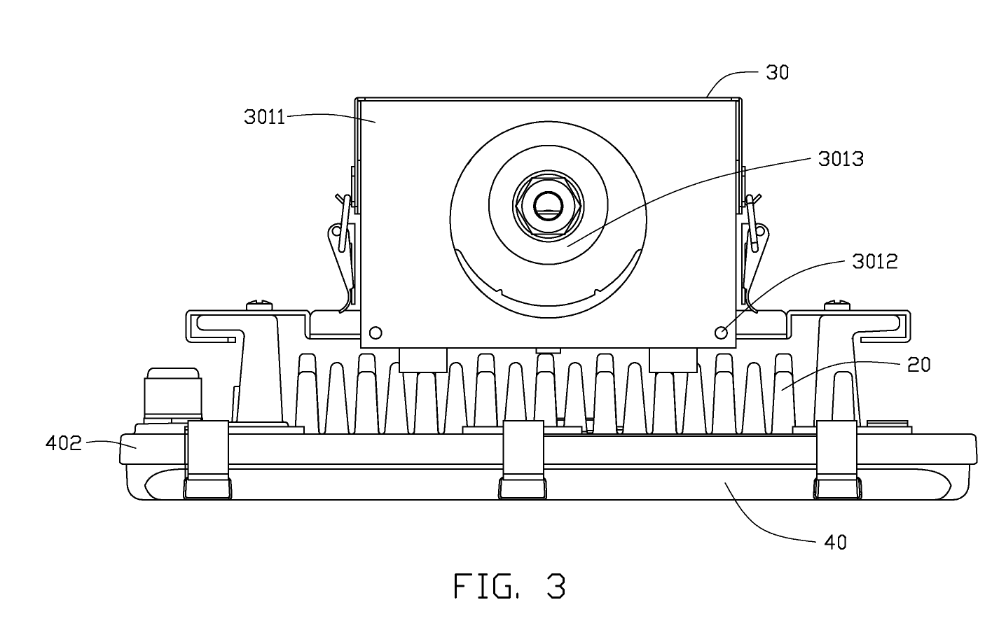

Referring to FIGS. 1 and 3, the seat 303 includes a first plane 3011. The first plane 3011 includes at least one aperture 3012, providing drainage, preventing water accumulation inside the lamp housing 30.

Referring to FIG. 4, the cover 304 and the seat 303 are fixed by fasteners 3034, 3036, providing waterproofing and dustproofing.

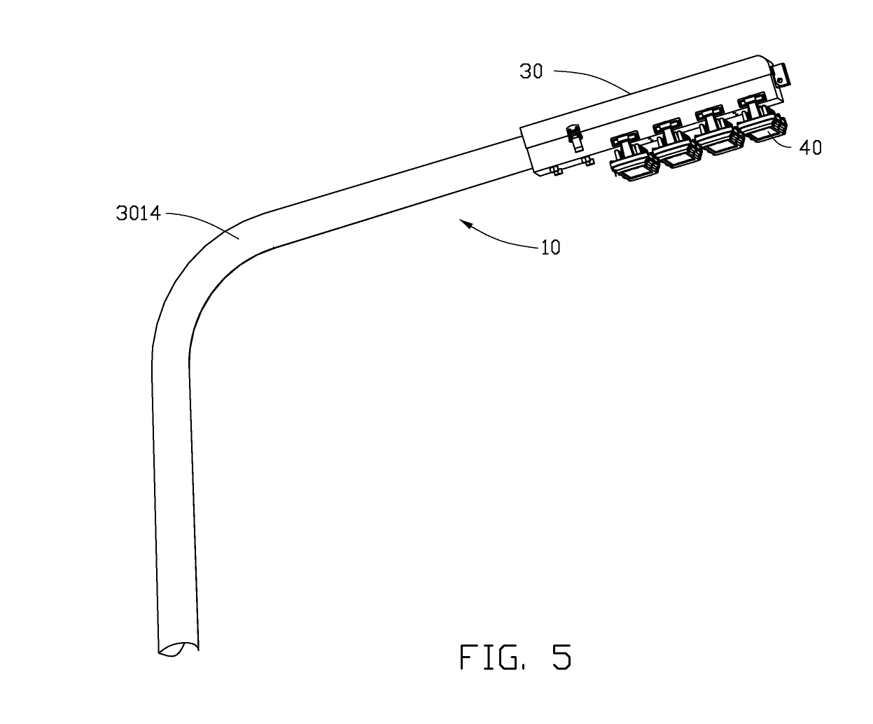

Referring to FIGS. 3 and 5, the first plane 3011 of the seat 303 defines a connecting hole 3013 in which a support 3014 of a streetlamp 10 is received. One end of the support 3014 connects to the ground and the other to the first plane 3011 of the seat 303.

Furthermore, the lamp housing 30 includes the power supply module 50, housed in the inner waterproof liner 302.

The lamp housing 30 provides a double layered structure, including the seat 303 and the cover 304 directly reducing the momentum and impact of rain, and inner waterproof liner 302 of waterproof material, through which the now slowed rain cannot pass.

Water or rain damage to power supply module 50 is thus prevented.

Further when moisture does pass through the cover 304 or the seat 303, it descends via gravity to the aperture 3012 of the first plane 3011, through which it exits without accumulating in the seat 303.

Referring to FIG. 3, the solid state lighting module 40 includes a solid state lighting source (not shown), a substrate 402, and a heat sink 20. The solid state lighting source can be a light emitting diode, organic light emitting diode, or laser; the power supply module 50 is housed in the inner waterproof liner 302, with solid state lighting module 40 electrically connected thereto. Thus, the power supply module 50 provides electrical power to a plurality of the solid state lighting modules 40.

Understandably, the shape of the inner waterproof liner 302 is not limited to this embodiment. The inner waterproof liner 302 can be square or circular (not shown).

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lamp housing, comprising: an outer shell and an inner waterproof liner, the inner waterproof liner housed in the outer shell, wherein a power supply module providing electrical power to at least one solid state lighting module is inside the inner waterproof liner, the outer shell includes a seat and a cover connecting to the seat, the seat includes a first plane defining at least one aperture and a connecting hole, the connecting hole connecting a support of a lamp and the aperture providing drainage of liquid in the lamp housing.

2. The lamp housing of claim 1, wherein the outer shell is made of one of metal and plastic.

3. The lamp housing of claim 1, wherein the inner waterproof liner is made of one of silicon and rubber.

4. The lamp housing of claim 1, wherein the support is used for supporting the lamp housing on a mounting surface.

5. An illumination apparatus, including a lamp housing, a power supply module, and at least one solid state lighting module, wherein the lamp housing comprises an outer shell and an inner waterproof liner, the inner waterproof liner is housed in the outer shell, the outer shell includes a seat and a cover connecting to the seat, the seat includes a first plane defining at least one aperture and a connecting hole, the connecting hole is used for connecting a support of a lamp, and the aperture is used for draining water in the lamp housing, the power supply module is inside the inner waterproof liner, providing electrical power to the at least one solid state lighting module below the seat.

6. The illumination apparatus of claim 5, wherein the outer shell is made of one of metal and plastic.

7. The illumination apparatus of claim 5, wherein the inner waterproof liner is made of one of rubble and silicon.

8. The illumination apparatus of claim 5, wherein the support is used for supporting the lamp housing on a mounting surface.

9. The illumination apparatus of claim 5, wherein the at least one solid state lighting module includes at least one solid state lighting source, a substrate and a heat sink.

10. The illumination apparatus of claim 9, wherein the solid state lighting source is a light emitting diode, an organic light emitting diode, or a laser.

11. The illumination apparatus of claim 5, wherein the at least one solid state lighting module includes a plurality of solid state lighting modules and the power supply module electrically connects to and provides electrical power to all the solid state lighting modules.
